(19) United States
(12) Patent Application Publication
(10) Pub. No.: US 2026/0245176 A1
(43) Pub. Date: Aug. 20, 2026

(54) MULTI-IMAGE FUSION SYSTEM AND METHOD

(71) Applicant: Morning dew Creative Technical Co., Ltd., Taoyuan City (TW)

(72) Inventors: Cheng-Ruei Tang, New Taipei City (TW); Yuan-Ting Fang, Taoyuan City (TW)

(21) Appl. No.: 19/180,086

(22) Filed: Apr. 15, 2025

(30) Foreign Application Priority Data
Feb. 19, 2025 (TW) 114105978

(51) Int. Cl. G06T 5/50

(52) U.S. Cl. CPC G06T 5/50; G06T 2207/20221

(57) ABSTRACT

A multi-image fusion system and a multi-image fusion method. The multi-image fusion system includes an image capture device and an image processor. The image capture device captures a target captured image of a target object. The image processor duplicates the target captured image to generate a duplicate target image. The image processor defines one of the target captured image and the duplicate target image as an original target image and the other as an initial target image. The image processor splits the initial target image into monochromatic light target images of a plurality of color light. The image processor fuses one or more of the monochromatic light target images with the original target image to output a specified color light fusion image.

### CROSS-REFERENCE TO RELATED PATENT APPLICATION

This application claims the benefit of priority to Taiwan Patent Application No. 114105978, filed on February 19, 2025. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to images, and more particularly to a multi-image fusion system and method.

### BACKGROUND OF THE DISCLOSURE

A multi-image fusion system requires multiple image capture devices, in which multiple lenses of the image capture devices each capture multiple images of the same target under different colors of light, and the multiple images are fused into a clear image, such as a single image where deep-level blood vessels in the human body are clearly observable.

Since the multiple lenses capture the multiple images in different directions and angles, the multiple images captured may have offset errors. Therefore, time needs to be spent in post-production to perform complex image recognition and fusion technologies for identifying and analyzing the contents of multiple images, aligning the similar contents of multiple images as much as possible, and then fusing the multiple images into a single image. However, due to the differences between the contents of the multiple images captured by the multiple lenses, the single image that is fused is still less than perfect.

### SUMMARY OF THE DISCLOSURE

In order to solve the above-mentioned problems, one of the technical aspects adopted by the present disclosure is to provide a multi-image fusion system. The multi-image fusion system includes an image capture device and an image processor. The image capture device is configured to capture a target captured image of a target object. The image processor is connected to the image capture device. The image processor is configured to duplicate the target captured image to generate a duplicate target image. The image processor is configured to define one of the target captured image and the duplicate target image as an original target image and the other as an initial target image. The image processor is configured to split the initial target image into a plurality of monochromatic light target images of a plurality of color lights. The image processor is configured to select one or more of the plurality of monochromatic light target images. The image processor is configured to fuse the selected one or more monochromatic light target images with the original target image to output a specified color light fusion image.

In order to solve the above-mentioned problems, another one of the technical aspects adopted by the present disclosure is to provide a multi-image fusion method. The multi-image fusion method includes the following steps of: capturing, by using an image capture device, a target captured image of a target object; duplicating, by using an image processor, the target captured image to generate a duplicate target image; defining, by using the image processor, one of the target captured image and the duplicate target image as an original target image and the other as an initial target image; splitting, by using the image processor, the initial target image into a plurality of monochromatic light target images of a plurality of color lights; selecting, by using the image processor, one or more of the plurality of monochromatic light target images; and fusing, by using the image processor, the selected one or more monochromatic light target images with the original target image to output a specified color light fusion image.

Accordingly, the present disclosure provides a multi-image fusion system and a multi-image fusion method. The multi-image fusion system and the multi-image fusion method of the present disclosure take a single image of a target object as a target captured image, duplicate the target captured image, saves one of the target captured image and the duplicated image, splits the other into a plurality of monochromatic light target images of a plurality of color lights, and selects one of the plurality of monochromatic light target images to be fused with the original target image to form a specified color light fusion image of a specified color light, such that the structure and outline of the target object (for example, but not limited to, the distribution of deep blood vessels in the human body) can be more clearly seen on the specified color light fusion image.

Compared to the existing image fusion system which uses multiple lenses of multiple image capture devices to respectively capture multiple images, the multi-image fusion system of the present disclosure only needs to use a single image capture device (i.e., only use a single lens) to capture a single target captured image, which is more cost-effective. Moreover, the target captured image and the monochromatic light target image that is split from the target captured image are captured by the same image capture device (i.e., by the same lens); therefore, when contents of the multiple images are superimposed and fused, they can be completely aligned with each other to obtain a specified color light fusion image having an improved fusion effect.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a block diagram of a multi-image fusion system according to a first embodiment of the present disclosure;

FIG. 2 is a flowchart of steps of a multi-image fusion method according to the first embodiment of the present disclosure;

FIG. 3 is a schematic diagram of the multi-image fusion system according to a second embodiment of the present disclosure;

FIG. 4 is a schematic diagram of the multi-image fusion system according to a third embodiment of the present disclosure; and

FIG. 5 is a flowchart of steps of the multi-image fusion method according to the third embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

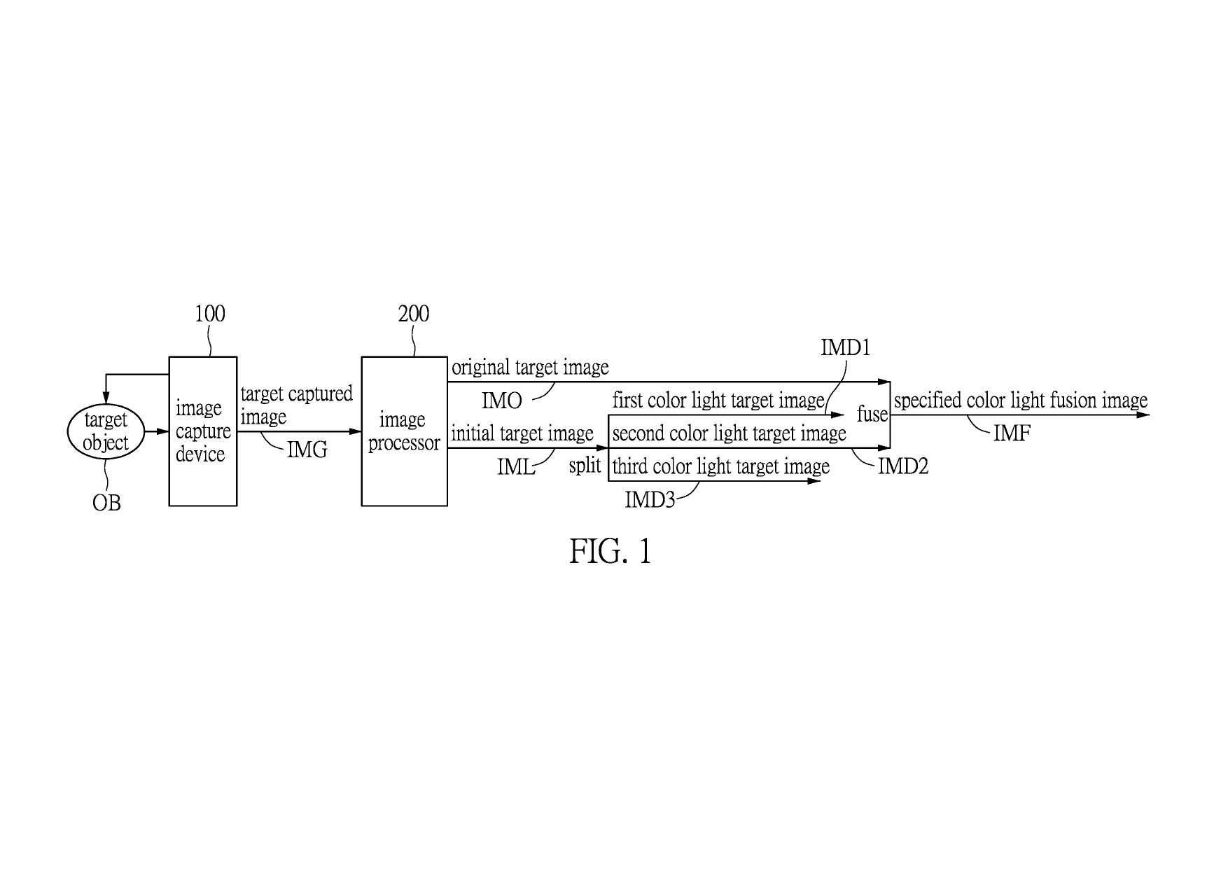

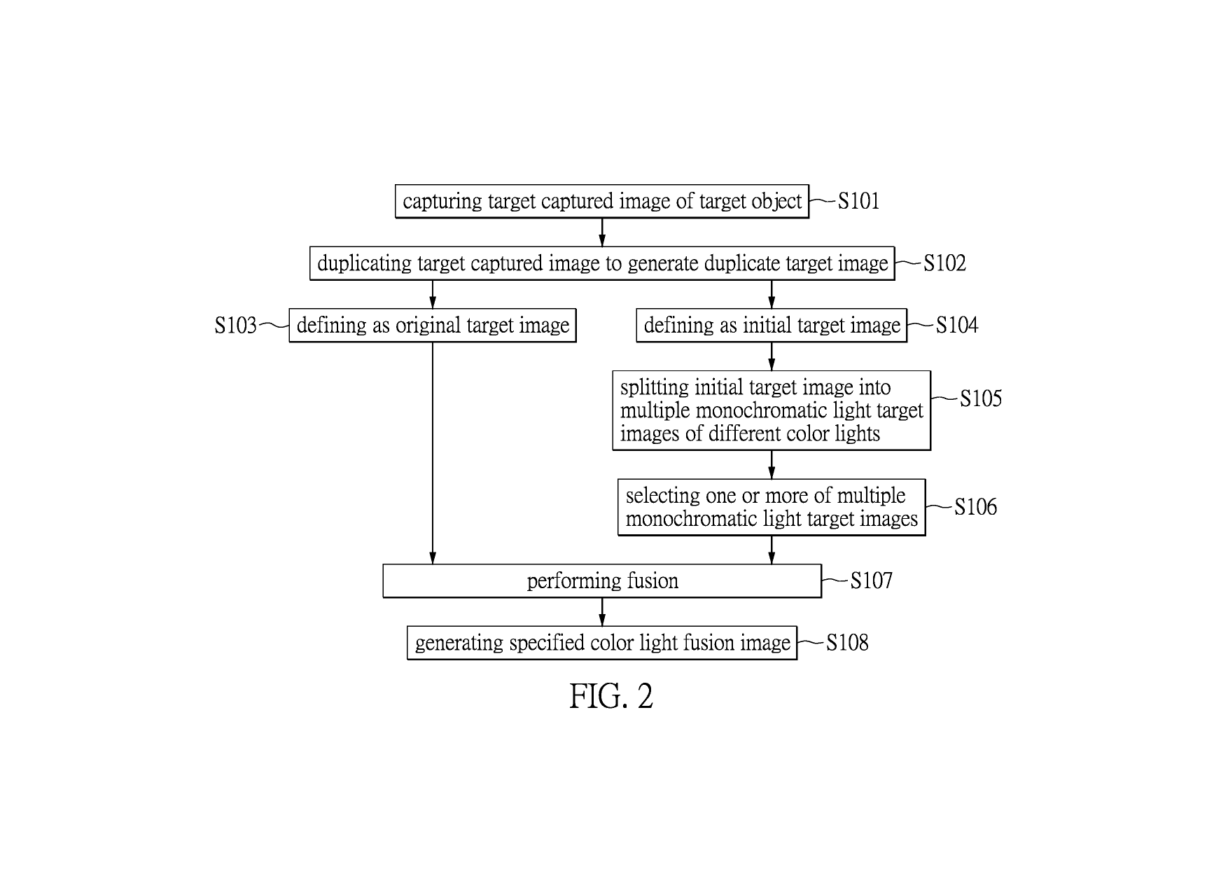

Referring to FIG. 1 and FIG. 2, FIG. 1 is a block diagram of a multi-image fusion system according to a first embodiment of the present disclosure, and FIG. 2 is a flowchart of steps of a multi-image fusion method according to the first embodiment of the present disclosure.

The multi-image fusion system of the present disclosure includes an image capture device 100 and an image processor 200 as shown in FIG. 1. The image processor 200 is connected to the image capture device 100. The multi-image fusion method of the present disclosure includes steps S101 to S108 as shown in FIG. 2, which are executed by the multi-image fusion system of the present disclosure.

The image capture device 100 captures a target captured image IMG of a target object OB (as shown in step S101 of FIG. 2), and the target object OB includes a living being (such as a human body or an animal), an object, or a combination thereof.

Then, the target captured image IMG captured by the image capture device 100 is duplicated to generate a duplicate target image that is the same as the target captured image IMG (as shown in step S102 of FIG. 2).

In order to execute different processing procedures on different images, the image processor 200 may use one of the target captured image IMG and the duplicate target image as an original target image IMO (as shown in step S103 of FIG. 2) and the other as an initial target image IML (as shown in step S104 of FIG. 2).

Next, the image processor 200 identifies an original color light of the initial target image IML, analyzes multiple monochromatic lights mixed into the original color light, and splits the initial target image IML into multiple monochromatic light target images of different color lights/hues (as shown in step S105 in FIG. 2), such as but not limited to a first color light target image IMD1, a second color light target image IMD2, and a third color light target image IMD3 as shown in FIG. 1. In practice, the number of the multiple monochromatic light target images into which the image processor 200 splits the initial target image IML may depend on other practical application requirements, such as for showing the target object OB more clearly.

The first color light target image IMD1 is the same as an image captured by the image capture device 100 when only a first color light irradiates the target body OB. The second color light target image IMD2 is the same as an image captured by the image capture device 100 when only a second color light irradiates the target body OB. The third color light target image IMD3 is the same as an image captured by the image capture device 100 when only a third color light irradiates the target body OB. The first color light, the second color light, and the third color light are lights of different colors. The initial target image IML is an image captured when original color light that is a combination of the first color light, the second color light, and the third color light irradiates the target body OB.

Next, the image processor 200 selects one or more of the multiple monochromatic light target images (as shown in step S106 of FIG. 2) that were split. For example, as shown in FIG. 1, in the first embodiment, the image processor 200 selects only the second color light target image IMD2 from the first color light target image IMD1, the second color light target image IMD2, and the third color light target image IMD3.

Finally, the image processor 200 fuses the selected one or more monochromatic light target images IMD1 to IMD3 (for example, the second color target image IMD2 shown in FIG. 1) with the original target image IMO (as shown in step S107 of FIG. 2) to output a single specified color light fusion image IMF of a specified color light (as shown in step S108 of FIG. 2).

It should be understood that since the duplicate target image is identical to the original target image IMO, in step S104 as shown in FIG. 2, regardless of selecting the target captured image IMG or the duplicate target image for subsequent splitting, the same specified color light fusion image IMF is generated.

It is worth noting that the second color light target image IMD2 and the original target image IMO that are fused are both captured by a single lens of the image capture device 100 in the same direction, angle, and position. Therefore, when the images are superimposed on each other for fusion, contents of the same multiple images (such as multiple structural features inside the human body) can be directly and completely aligned to obtain the specified color light fusion image IMF having a good fusion effect.

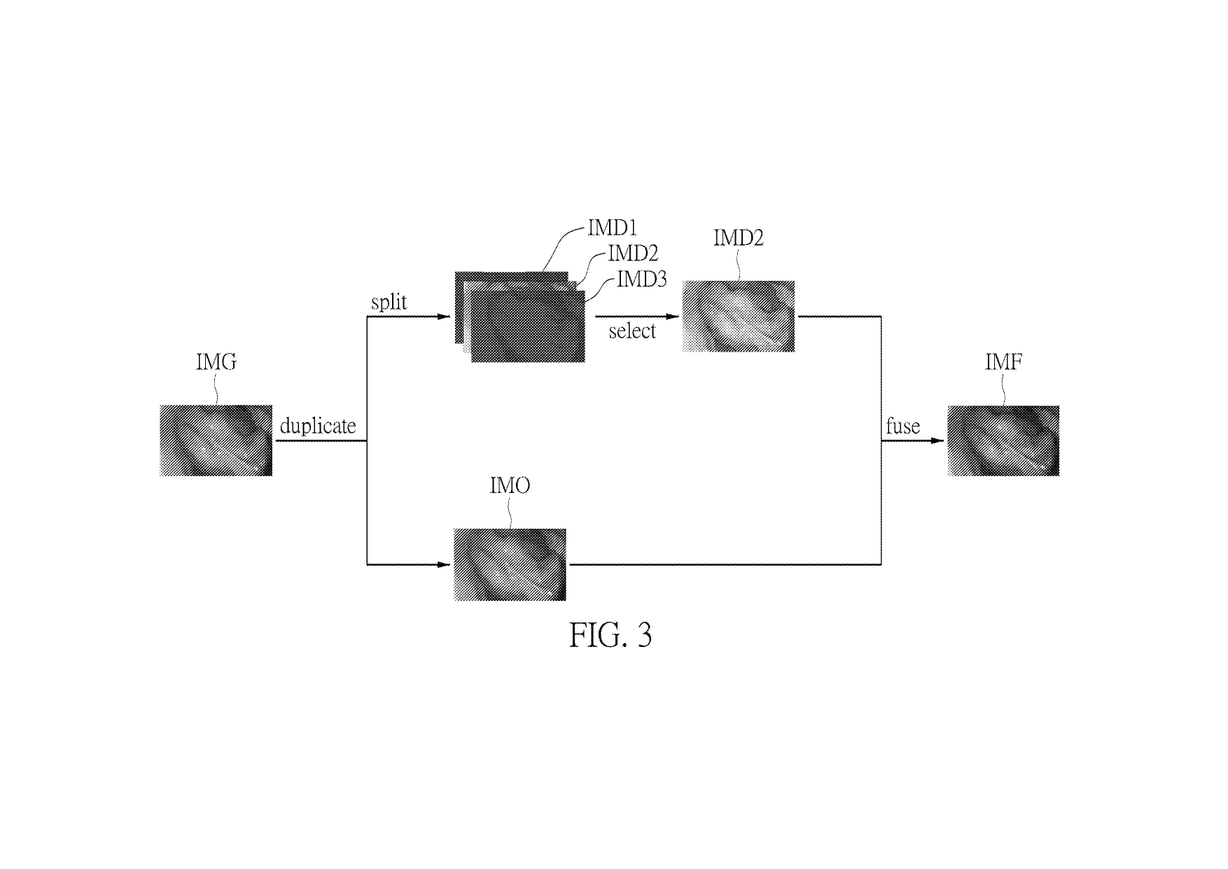

Referring to FIG. 3, FIG. 3 is a schematic diagram of the multi-image fusion system according to a second embodiment of the present disclosure.

In the second embodiment, for example, the image capture device 100 shown in FIG. 1 captures an image of a body part (as the target object OB) inside the human body as the target captured image IMG.

The image processor 200 shown in FIG. 1 duplicates the target captured image IMG received from the image capture device 100 to generate a duplicate target image as the original target image IMO. As shown in FIG. 3, the original target image IMO is completely identical to the target captured image IMG.

The image processor 200 shown in FIG. 1 uses a target captured image IMG captured by the image capture device 100 as the initial target image IML. The first color light target image IMD1, the second color light target image IMD2, and the third color light target image IMD3 split from the initial target image IML in FIG. 3 are respectively a red light target image, a green light target image, and a blue light target image.

The red light target image is the same as an image captured by the image capture device 100 when only red light irradiates the target body OB. The green light target image is the same as an image captured by the image capture device 100 when only green light irradiates the target OB. The blue light target image is the same as an image captured by the image capture device 100 when only blue light irradiates the target object OB.

The target captured image IMG is an image captured by the image capture device 100 when a white light that is a combination of red light, green light, and blue light illuminates a body part (serving as the target body OB) inside the human body.

The image processor 200 selects, for example but not limited to, the second color target image IMD2 of green light from the first color target image IMD1 of red light, the second color target image IMD2 of green light, and the third color target image IMD3 of blue light, and fuses the second color target image IMD2 with the original target image IMO to output the specified color light fusion image IMF.

As shown in FIG. 3, compared to the target captured image IMG, the specified color light fusion image IMF generated after fusion can more clearly show the internal structure of the human body (such as but not limited to the blood vessels on the tongue inside the mouth) for the human eye.

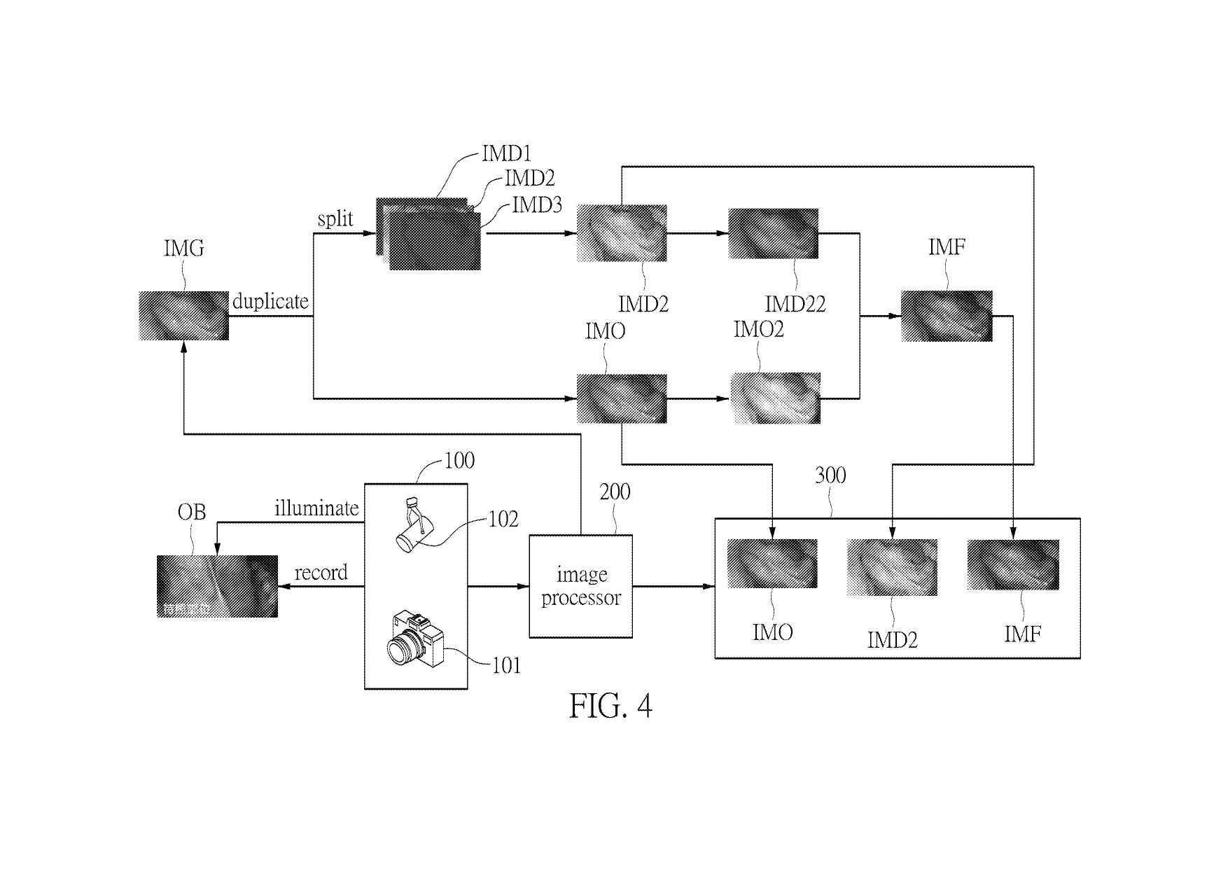

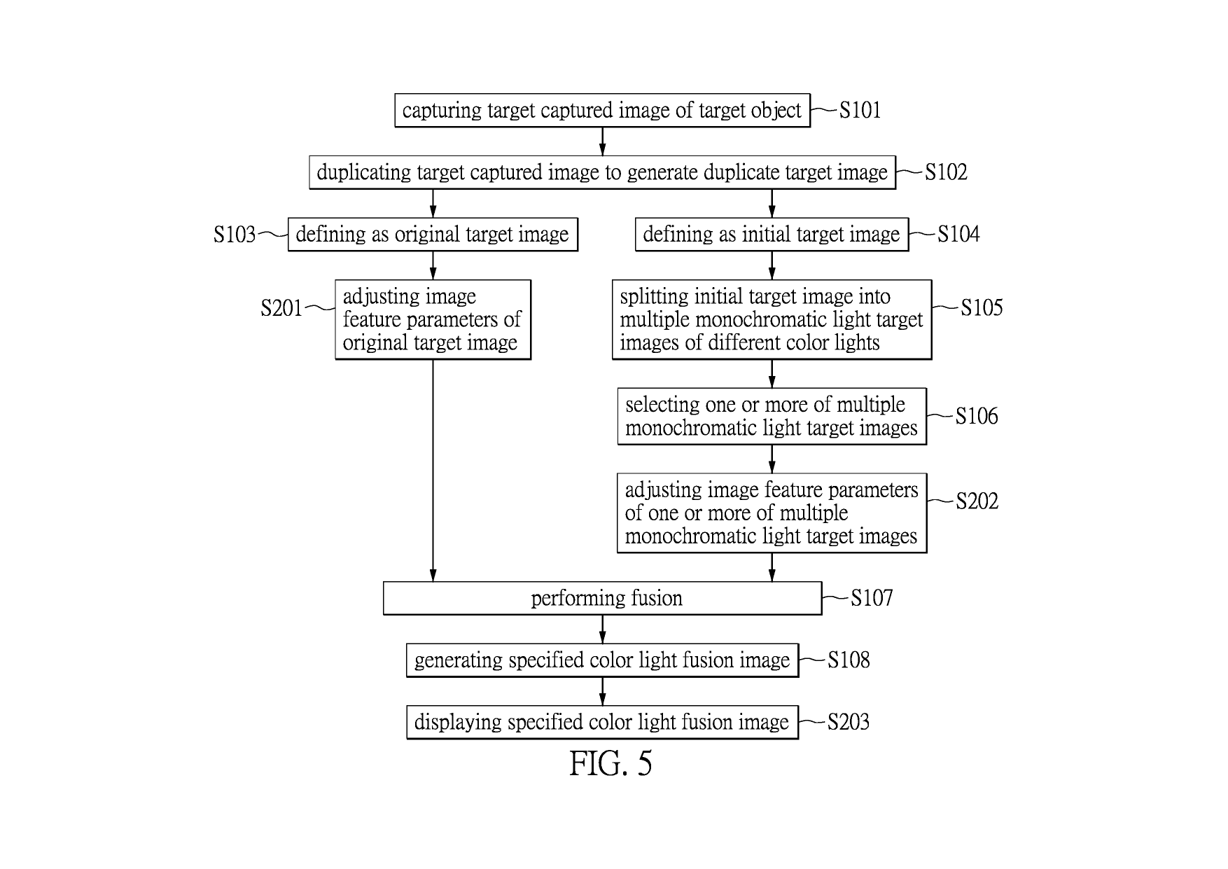

Referring to FIG. 4 and FIG. 5, FIG. 4 is a schematic diagram of the multi-image fusion system according to a third embodiment of the present disclosure, and FIG. 5 is a flowchart of steps of the multi-image fusion method according to the third embodiment of the present disclosure.

As shown in FIG. 4, the multi-image fusion system of the present disclosure includes the image capture device 100 and the image processor 200. The image processor 200 is connected to the image capture device 100.

For example, as shown in FIG. 4, the image capture device 100 is, for example, an endoscope, and includes an illumination device 102 and a single-lens camera 101.

The multi-image fusion method of the present disclosure may include steps S101 to S108 as shown in FIG. 2, and may further include steps S201 to S203 as shown in FIG. 5. The multi-image fusion method is executed by the multi-image fusion system of the present disclosure as shown in FIG. 4, or, practically, executed by the multi-image fusion system of the present disclosure as shown in FIG. 1.

Before the original target image and the selected monochromatic light target image are fused into the specified color light fusion image IMF (i.e., after executing steps S101 to S106 and before executing step S107), the image processor 200 may first adjust one or more image feature parameters of the original target image IMO (as shown in step S201 in FIG. 5) to generate an original adjusted target image IMO2.

Additionally or alternatively, before the original target image and the selected monochromatic light target image are fused into the specified color light fusion image IMF (i.e., after executing steps S101 to S106 and before step S107), the image processor 200 may first adjust the brightness, the contrast, or other one or more image feature parameters of the selected one or more monochromatic light target images (as shown in step S202 of FIG. 5) to generate one or more monochromatic adjusted target images. For example, a second color target image IMD22 is formed by adjusting the brightness, the contrast, or other one or more image feature parameters of the second color target image IMD2.

For example, the image processor 200 adjusts the brightness and the contrast of the original target image IMO and the brightness and the contrast of a selected monochromatic light target image (e.g., the second color light target image IMD2), such that when the two images are fused into the specified color light fusion image IMF to be output to a display device 300 for display (as shown in step S203 of FIG. 5), the structural features inside the human body are presented more clearly.

If necessary, the image processor 200 may further output the second color light target image IMD2 and the original target image IMO to the display device 300 for display as shown in FIG. 5. In practice, the image processor 200 can further output the second color light target image IMD22 and the original adjusted target image IMO2 to the display device 300 for display.

In summary, the present disclosure provides a multi-image fusion system and a multi-image fusion method. The multi-image fusion system and the multi-image fusion method of the present disclosure take a single image of a target object as a target captured image, duplicate the target captured image, save one of the target captured image and the duplicated image, split the other into a plurality of monochromatic light target images of a plurality of color lights, and select one of the plurality of monochromatic light target images to be fused with the original target image to form a specified color light fusion image of a specified color light, such that the structure and outline of the target object (for example, but not limited to, the distribution of deep blood vessels in the human body) can be more clearly seen on the specified color light fusion image.

Compared to the existing image fusion system which uses multiple lenses of multiple image capture devices to respectively capture multiple images, the multi-image fusion system of the present disclosure only needs to use a single image capture device (i.e., only use a single lens) to capture a single target captured image, which is more cost-effective. Moreover, the target captured image and the monochromatic light target image that is split from the target captured image are captured by the same image capture device (i.e., by the same lens); therefore, when contents of the multiple images are superimposed and fused, they can be completely aligned with each other to obtain a specified color light fusion image having an improved fusion effect.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A multi-image fusion system, comprising:
an image capture device configured to capture a target captured image of a target object; and
an image processor connected to the image capture device, and configured to execute the following processes of:
duplicating the target captured image to generate a duplicate target image;
defining one of the target captured image and the duplicate target image as an original target image and the other as an initial target image;
splitting the initial target image into a plurality of monochromatic light target images of a plurality of color lights;
selecting one or more of the plurality of monochromatic light target images; and
fusing the selected one or more monochromatic light target images with the original target image to output a specified color light fusion image.

2. The multi-image fusion system according to claim 1, wherein the plurality of monochromatic light target images include a red light target image, a green light target image, and a blue light target image.

3. The multi-image fusion system according to claim 1, wherein the image processor is configured to adjust one or more image feature parameters of the selected one or more monochromatic light target images before fusing the selected one or more monochromatic light target images with the original target image.

4. The multi-image fusion system according to claim 1, wherein the image processor is configured to adjust one or more image feature parameters of the original target image before fusing the selected one or more monochromatic light target images with the original target image.

5. A multi-image fusion method, comprising the following processes:
capturing, by using an image capture device, a target captured image of a target object;
duplicating, by using an image processor, the target captured image to generate a duplicate target image;
defining, by using the image processor, one of the target captured image and the duplicate target image as an original target image and the other as an initial target image;
splitting, by using the image processor, the initial target image into a plurality of monochromatic light target images of a plurality of color lights;
selecting, by using the image processor, one or more of the plurality of monochromatic light target images; and
fusing, by using the image processor, the selected one or more monochromatic light target images with the original target image to output a specified color light fusion image.

6. The multi-image fusion method according to claim 5, further comprising the following process:
splitting, by using the image processor, the target captured image into a red light target image, a green light target image, and a blue light target image, which are included in the plurality of monochromatic light target images.

7. The multi-image fusion method according to claim 5, further comprising the following process to be executed before fusing the selected one or more monochromatic light target images with the original target image:
adjusting, by using the image processor, one or more image feature parameters of the selected one or more monochromatic light target images.

8. The multi-image fusion method according to claim 5, further comprising the following process to be executed before fusing the selected one or more monochromatic light target images with the original target image:
adjusting, by using the image processor, one or more image feature parameters of the original target image.
